(19) United States
(12) Patent Application Publication
(10) Pub. No.: US 2006/0095764 A1
(43) Pub. Date: May 4, 2006

(54) Method, system and computerized medium for making secure message transmission

(76) Inventors: Roger Suanez, Le Pouliguen (FR); Patricia Etienne, Le Pouliguen (FR)

Correspondence Address: YOUNG & THOMPSON, 745 SOUTH 23RD STREET, 2ND FLOOR, ARLINGTON, VA, 22202, US

(21) Appl. No.: 10/520,156

(22) PCT Filed: Jul. 4, 2003
(86) PCT No.: PCT/FR03/02074

§ 371 Date: Sep. 23, 2005

(30) Foreign Application Priority Data
Jul. 4, 2002 (FR) 02/08418

(51) Int. Cl. H04L 9/00

(52) U.S. Cl. 713/168

(57) ABSTRACT

A method for making secure message transmission includes a step of transmitting the message and its signature by the transmitter (1) as well as an identification information of the transmitter (CRYPTIDENT) and a supplementary information derived from the message (IDEM), and the receiver (2) likewise determines an information derived from the content of the received message and compares it to the transmitted corresponding information (IDEM) to validate the message in case of conformity.

This invention pertains to a method for secure message transmission.

In securing messages, the known method is to determine the signature of a message and to transmit said signature along with the message in order to allow a receiving device that has a key that is paired with a key that was used to generate the message signature either to decode the signed message or to calculate another signature from the paired key and to compare it to the signature that is received. A paired key is defined here as a public key that is associated with a private key by a public key encryption algorithm, or as two known secret keys, whereby one of them, from a first entity, makes it possible to encode a transmitted message, and the other, for decoding a message received from another entity, has the other key that makes it possible to decode the messages received from the first entity or to encode the messages sent to the first entity.

These techniques for encoding communications under a protocol that is secured by asymmetric cryptography (for example, public cryptography) or symmetric cryptography have the disadvantage that, at the end of a transport or transfer cycle, the decomposed and signed contents are not always at the meeting point and the receiver is not able to certify that the message received corresponds exactly to the one that was sent and that, among other things, the self-certifying authority cannot verifiably prove the integrity of the contents when they have been accidentally or deliberately altered during a cycle of their transfer. As a matter of fact, it can happen that the message and the signature are, by accident or by design, both altered in a coordinated way such that the alteration cannot be detected at the end of the self-certification cycle.

The inventors also considered the fact that the problem of the risk of a message being altered arises from the fact that the transmitter loses control over access to the message. However, this same problem arises in cases where data are stored in a personal computer with poor access control or in any other means of local or remote storage.

Access to the means of storage can thus be gained via an internal short-range link to a personal-computer hard disk and, when the link is protected, during data transfer, owing to the fact that the link is internal and the user is present, but it is important, after data is stored, to protect access to the hard disk and thus to protect this link in particular.

When the means of storage is remote, the transmitter obtains access to it over a dedicated line or, in general, via a local or general computer network, for example the Internet. In such cases, the message can be diverted or modified by a third party when it is transmitted.

The goal of the invention is thus to improve the effectiveness with which verification is done of the integrity of a block of data whose creator has lost access control thereto because it has been transmitted. The data can be in any form, for example, electronic form, optical memory, or else hard copy.

To accomplish this goal, the invention first concerns a process for securing the transmission of a message from a transmitter to a receiver; in said process the transmitter generates and integrates with the message a signature so as to produce a signed message that is characterized by the fact that said process includes the following stages:

the transmitter associates with the signed message transmission checking information that derives from the signed message according to a specified law, and

the transmitter generates and sends to the receiver data that represent the signed message and the transmission checking information;

and the receiver:

receives said transmitted data;

determines, according to said law, the reception checking information deriving from the message that is received; and

compares the reception checking information against the transmission checking information in order to validate the received message in the event that they coincide.

As used above, the term “message” should be understood to refer to any set of transmitted data, whereby said data set is not necessarily transmitted over a computer network link, can be in any format and, in particular, may lack addresses for the transmitter and receiver.

The checking information thus makes it possible to effectively check the valid content of the message and, if need be, the signature as well. The transmitter and the receiver may be human users or data processing devices. It should be noted that the transmission checking information can be transmitted separately from the message.

In a preferred embodiment, the above-mentioned law implements a mathematical function.

The processing can thus be done by means of blocks of bits that represent, for example, a character in the message. This kind of parallel and combined bit processing offers many more combinations than a serially processed logical function, such as, for example, an exclusive OR function. It is also faster to carry out block processing in a classical central processing unit, which is designed for performing logical functions only and is thus unable to process multiple bits independently in parallel.

The transmitter preferably generates and also transmits information for identifying the transmitter; this personalizes said law, and the receiver likewise personalizes the law based on the transmitter identification information that is received in order to determine the reception checking information.

The transmitter's status thus represents an additional checking key.

The transmitter advantageously sets up said law such that the transmission checking information is representative of at least one kind of information that is selected from the group that consists of the message consistency information and the message meaning information.

Thus, the structure of the message and/or the meaning of the information that it contains can be verified because the structure/meaning is reflected in the checking information.

The consistency information of the message can be determined, for example, by means of a first quotient that is obtained by dividing the transmitter identification information by a number of characters that are contained in the message.

In this case, a first remainder that is obtained by the above-mentioned division step can itself be divided by a first number in order to obtain a second quotient and a second remainder, whereby the second remainder is added to a constant to obtain a predetermined number of characters, for message consistency, after conversion into a base that is selected from among a set of conversion bases.

The remainder from the second quotient can be further divided by a first number in order to obtain a third quotient that is associated with a third remainder, whose value is added to a constant in order to obtain the message consistency information.

The first number is, for example, 46027, and the constant is, for example, 4623.

The message consistency information is preferably represented by characters, the number of which is less than a threshold that represents a specified percentage relative to a size of the transmitted data.

The message meaning information is determined, for example, by adding a specified number of alphanumeric characters of the message, whereby each alphanumeric character has a value that is twice the ASCII value that is representative of the character in question, minus an ASCII value that is representative of an adjacent character, whereby the resulting sum is taken as the divisor of a dividend, which is the transmitter identification information, so as to obtain the message meaning information.

The message meaning information is preferably represented by characters, the number of which is below a threshold that represents a specified percentage relative to a size of the data transmitted.

The transmitter identification information is obtained, for example:

by a stage for transcoding of strings, of specified sizes, of alphanumeric characters that represent data fields to be protected, thus providing a first set of intermediate results, each of which has a specified number of digits, and

a stage for transforming the first set of intermediate results by means of a transformation algorithm that is randomly selected from among a set of algorithms, each of which uses an alphanumeric-character base that is specific to the algorithm in question in order to obtain a final result after a conversion matrix is used to convert the characters of the alphanumeric base of the selected algorithm into characters having numerical values of a predetermined base.

The transmitter identification information is preferably transmitted in encoded form by transforming the transmitter identification information using a specified base into an encoded result with a specified number of digits that are expressed in a mathematical base that is randomly selected from a set of conversion bases in order to obtain an encoded identifier of the transmitter; into said encoded identifier information for identifying the selected mathematical base is inserted at a variable rank that is specified by a pointer that is inserted at a rank for which the receiver has information for determining said rank.

In this case, the rank of the identification information of the selected mathematical base is defined, for example, by an integer quotient that is obtained by dividing a particular value, which is associated with the pointer by a table, by a number that specifies the size of the set of algorithms.

The rank of the pointer is inserted, for example, at a rank that is calculated by taking the sum, modulo 9, of ASCII codes of an intermediate result as specified above that represents terms that specify a mathematical function that determines the transmitter identification information.

In one embodiment, the receiver:

calculates the sum of the ASCII codes of at least one block of data of the above-mentioned alphanumeric data field, whereby said block is received in the transmitter identification information;

expresses said sum in modulo 9 in order to determine the rank of the pointer;

reads said pointer that is received, and

calculates the rank of the identification information of the selected mathematical base by dividing the particular value associated with the pointer by the value that represents the size of the set of algorithms expressed in a predetermined base, and

exploits the encoded information that is received after eliminating therefrom the identification information of the selected mathematical base and the pointer.

The data representing the message can be transmitted to the receiver via a data storage system.

In this case, the receiver can also be the transmitter, i.e., the party creating the useful data can later read them again after they are stored locally or remotely and verify their integrity.

The invention also pertains to a security system for implementing the process of the invention, whereby said system includes a transmitter associated with a receiver; here the transmitter is designed to generate and integrate into the message a signature for producing a signed message; this system is characterized by the fact that:

the transmitter includes:

means for generating and associating with the signed message transmission checking information that derives from the signed message according to a specified law, and

means of transmitting to the receiver data that represent the signed message and the transmission checking information;

and the receiver includes:

means for receiving said transmitted data,

means for determining, according to said law, reception checking information deriving from the received message, and

means for comparing the reception checking information against the transmission checking information in order to validate the received information in the event that they coincide.

The transmission means are also preferably controlled by means for generating transmitter identification information that were used to personalize said law, and the receiver likewise contains means for personalizing the law according to the transmitter identification information received by the receiving means that control the means of determining the reception checking information.

The transmitter is preferably designed such that said law causes the transmission checking information to be representative of at least one kind of information selected from among the group composed of the message consistency information and the message meaning information.

The various above-cited means of the transmitter and the receiver can be hardware elements or circuits that are wired to perform their functions and/or software elements that run on said hardware elements or, if appropriate, on an arithmetic central processing unit that divides its time between these functions and optionally other functions that are external to the invention. Each function according to the invention can thus be in the form of a piece of software stored on a computer medium of fixed or removable memory, for example, a hard disk, a diskette, a CD-ROM, a chip card, or other medium located close to the transmitter or the receiver, or it can be remote therefrom but accessible thereto. The chip card can also include some or all of the processing means that run the software.

Finally, the invention pertains to a data medium that contains a set of software for a computer system for implementing the process of the invention, whereby the set of software used includes at least one of the following two subsets:

a first subset for the transmitter that contains software for controlling the system that associates with the signed message the transmission checking information deriving from the signed message according to a specified law, and software for controlling the generation and transmission to the receiver of the data that represent the signed message and the transmission checking information, and

a second subset for the receiver that contains software for receiving the above-mentioned transmitted data, software for determining, according to said law, the reception checking information deriving from the received message, and software for comparing the reception checking information against the transmission checking information in order to validate the received message in the event that they coincide.

The first subset can also contain software for generating and transmitting transmitter identification information that was used to personalize said law, and the second subset contains software that was likewise used for personalizing this law according to the transmitter identification information that is received in order to determine the reception checking information.

Said law can be set up such that the transmission checking information is representative of at least one kind of information selected from among the group that consists of the message consistency information and the message meaning information.

The data medium can be a chip card.

The invention will be better understood from the following description of a preferred embodiment of the process of the invention and by referring to the attached drawing, where:

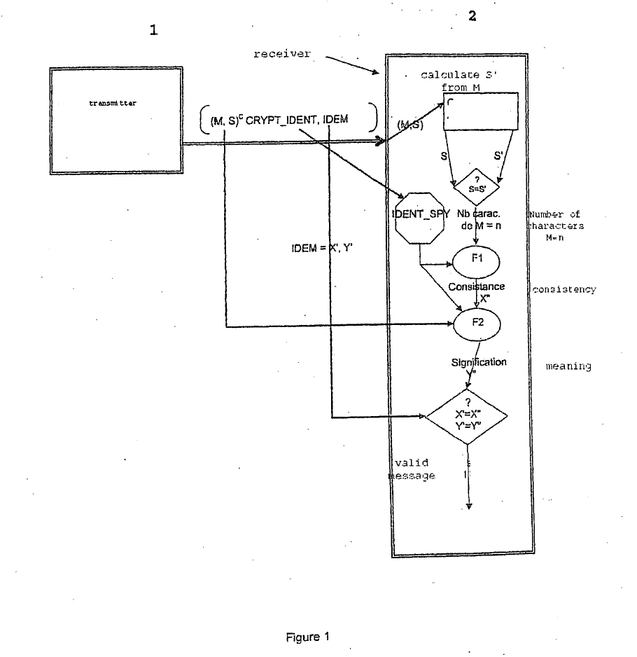

FIG. 1 shows an overall view of the means required for implementing the process of the invention, which consist of a transmitter and a receiver that are connected by a message transmission line;

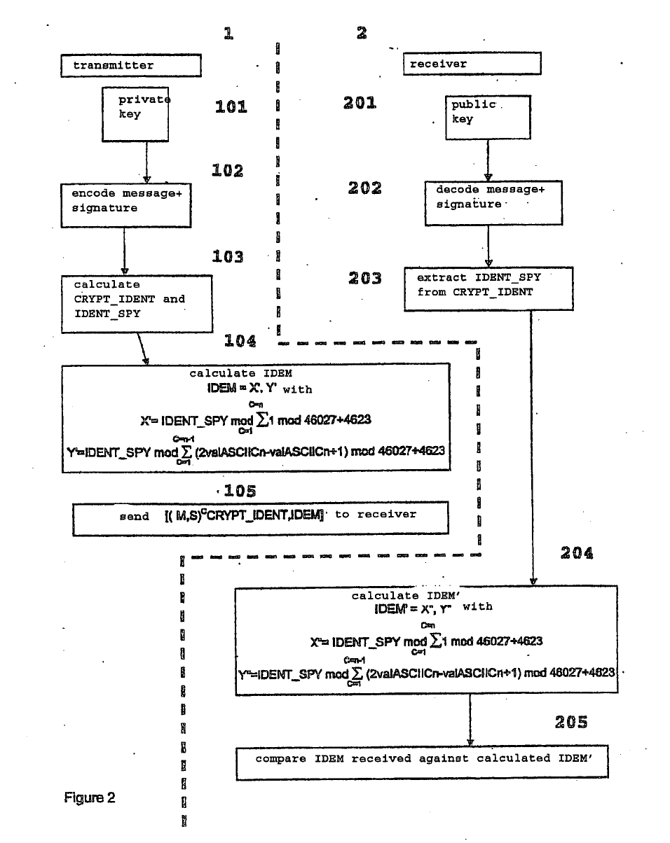

FIG. 2 shows in schematic form a detailed view of the operations that take place at the level of the transmitter and receiver;

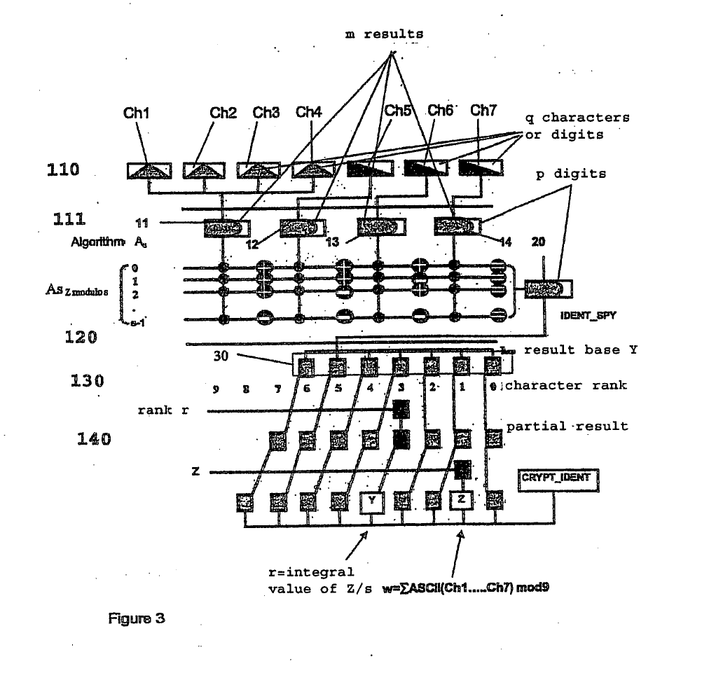

FIG. 3 shows in schematic form a detailed view of the information for generating the encoding for protecting the message contents that are present at the transmitter, and

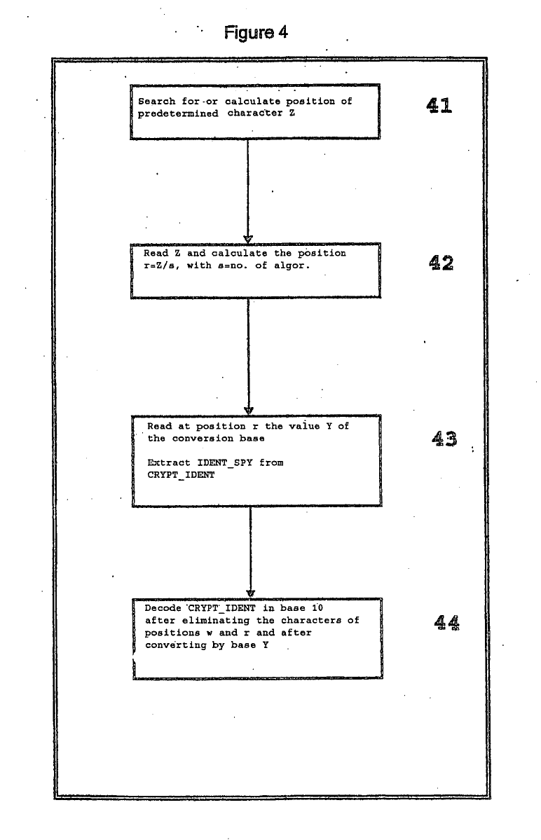

FIG. 4 shows the stages for determining the transmitter identification information IDENT_SPY for use in the operations depicted in FIG. 2 based on the encoded identification information.

Looking at FIGS. 1 and 2, in a classical transmission of information messages between two computer terminals, respectively a transmitter 1 and a receiver 2 through a communication line. At stage 101 (FIG. 2), the transmitter 1 reads a secret key in order to perform on the contents of message M a calculation of a signature S at a stage 103, whereby said signature is then attached to the contents of the message in order to create a signed message, which optionally undergoes an encoding operation C, stage 103, whereby the encoded signed message (M,S)^{c} is then transmitted at a stage 105 to the receiver 2 over the communication line.

Using a symmetric or asymmetric decoding algorithm, stage 202, after reading a public key, stage 201, the receiver 2 then decodes the encoded signed message if necessary in order to extract therefrom the valid contents of the message and the signature that is received. The receiver 2 performs on these contents the same calculation as was performed by the transmitter 1 in order to determine locally a new signature S′, which it compares with the signature S that is received. If the comparison indicates they are the same, the receiver 2 assumes that the message received, and thus the valid contents, are the same as those that were transmitted.

Nevertheless, this process is not infallible because, for example, the receiver 2 will not detect that a forger has switched the positions of characters within the contents of the message because the signature does not always detect it, nor will it detect that it has received from the forger a message whose contents have been dictated by the latter but has a valid signature, optionally in place of an authentic signed message.

According to the process that is illustrated in greater detail in FIG. 2, at a stage 104 the transmitter 1 also calculates transmission signature information IDEM that derives from the message according to a specified law. In this example, the transmitter 1 also calculates, in a randomly determined identity calculation base Y, the transmitter identification information, IDENT_SPY, which is optionally encoded into CRYPT_IDENT, to which the transmitter 1 attaches identification information of base Y. The combination of these pieces of information, IDEM and IDENT_SPY or CRYPT_IDENT, is then transmitted to the receiver 2.

The transmitter 1 thus associates with the signed message transmission checking information IDEM that derives from the signed message according to the specified law, and the transmitter 1 generates and transmits to the receiver 2 data that represent the signed message and the transmission checking information IDEM, as well as, in this example, the transmitter identification information, IDENT_SPY, which personalizes the law.

When the receiver 2 receives this information, it will, if necessary, first decode (C⁻¹) the encoded portion of the message and then calculate a signature S′ based on the contents of the decoded message M and compare it to the signature S that is received in order to verify that the two signatures are identical.

In cases where the results of this initial comparison are positive, the receiver 2 determines, according to said law, reception checking information IDEM′ that derives from the received message, and it compares the reception checking information IDEM′ against the transmission checking information IDEM in order to validate the received message in the event that they coincide.

Said law implements a mathematical function here.

In this case, the receiver 2 proceeds with its process for validating the message by determining from the transmitter identification information IDENT_SPY or encoded CRYPT_IDENT, stage 203, the above-indicated information that makes it possible to recover the calculation base Y for the value of the identification information of the transmitter 1, i.e., the terminal or its user, IDENT_SPY, which consists of a series of, for example, 11 to 12 digits or characters, each of which has a particular numerical value.

At a stage 204, the information for identifying transmitter 1, IDENT_SPY or CRYPT_IDENT, is combined here by the receiver 2 with a number, identified in advance, of alphanumeric characters that constitute the message in order to derive therefrom consistency information X″ for the message being received. The information for identifying the transmitter 1 IDENT_SPY is also combined here with ASCII values that are representative of each of the characters in the message in order to derive therefrom meaning information (Y″) from the message being received. The receiver 2 then, stage 205, compares the consistency information and meaning information X″, Y″ that are calculated upon reception, against the corresponding transmitted message consistency information and message meaning information X′, Y′, which are contained in the transmission checking information deriving from the message IDEM.

In addition to the above-indicated stages, references 101 to 105 and 201 to 205 also refer to two sets of processing calculation blocks, hardware and/or software circuits of the transmitter 1 and the receiver 2, respectively, which are provided in order to carry out the above-indicated functions.

The consistency information of the message upon reception X″ is calculated here by the receiver 2 by applying the following algorithm:

The receiver 2 uses here a number that represents the transmitter identification information IDENT_SPY, each character of which represents a particular value, and carries out a first division step by dividing this number by a value of a number that represents the number of characters in the message.

A first remainder that is obtained in the first division step is, in a second division step, itself divided by a first number that consists of, for example, the first number 46027.

A second remainder that is obtained in the second division step is added here to a value 4623 in order to guarantee that the results are always within the value limits that make it possible to encode this result, in one of the bases of the set of conversion or condensation bases in the form of a limited set of alphanumeric characters, for example, 3 characters.

The set of conversion bases can consist of, for example, bases between base 37 and base 127. Base 82, which is the mean value of the bases that fall within the range of characters of the bar code 128, serves as a reference for estimating on average how robust this process is in resisting brute force cracking.

Appendix 1 shows the matrix for bijective conversion of the characters in base 37 into the decimal base, and vice versa.

Appendix 2 shows the base 67 conversion matrix that makes it possible to convert the 67 alphanumeric characters of column b67 into decimal-base numbers as shown in column b10, and vice versa.

Note that, while the decimal base constitutes a classic base that serves here as a reference, any other reference base can also be used.

In order to obtain the meaning information of the message upon receipt Y″, here the receiver 2 also uses the identification information IDENT_SPY as a dividend for dividing this value by the sum of a certain number of numerical-value elements, each of which itself corresponds to one of the particular characters in the message. Here, the value of each element is twice the ASCII value of a character of rank k, minus the ASCII value of the next character of rank k+1, according to a predetermined order of progression, in one direction or the other. The remainder that is obtained in this way is itself divided here by the first number 46027, and the remainder that is obtained is added to the value 4623 here in order to determine a value that is represented in one of the selected bases, for example, in base 37 or base 67, in the form of 3 characters.

The consistency value X″ and meaning value Y″ that are calculated upon receipt are compared against the corresponding values X′ and Y′ that are transmitted with the message M or separately from it and have been calculated by the transmitter 1. The meaning value Y′, as will be understood from the example given below, is determined in such a way that the value of the transmitter identification number IDENT_SPY, which is fixed in order to limit the memory register capacity, is extended in this example between 32259945714 and 32259948772 when it is divided, by the first division step, by the divisor that is produced from the ASCII values of the characters or from the number of characters, as explained above, and which can thus take on a value that in this example is between 003210985 and 333210952.

Thus, when the first remainder, which is obtained by the first division step, is divided by the first number 46027 in the second division step, a second remainder is obtained to which the constant value 4623 is added. In the first case, as regards verification of the consistency of the message, the value 4623 is obtained in base 10 which, when converted to base 37, has the value “3dz” and, when converted to base 67, “120”. In the second case, as regards the meaning of the message, 50649 is obtained in base 10, which, when represented in base 37, takes on the value “Aax” and, in base 67, the value “bi£”. The three pieces of information (the first piece of information, transmitter identification information CRYPT_IDENT, and the second and third pieces of information, message consistency X′ and message meaning Y′) that are thus added to or combined with the message constitute, for the first item, a piece of information that is distinguished independently from the next two pieces of information.

The first piece of information, transmitter identification information CRYPT_IDENT, is obtained from a block of predetermined length, also called here a truncature, of several characters that are heavy in weight here, among which is placed, at a randomly drawn rank, a character that represents the mathematical base Y for expressing the result of the calculation.

The first piece of information, transmitter identification information CRYPT_IDENT, constitutes a first block that forms a condensed identity of an individual or corporation or a document or an object; this condensed identity is obtained by applying a calculation algorithm As that is randomly drawn from among a set of algorithms that are of size s and wherein the different terms and constants of the mathematical function are composed of converted numbers that are expressed in a specified base, in this case the decimal base, and come from the various alphabetic and numeric data fields that identify the corporation, individual, object, document, or information to be authenticated in the transmission.

The second piece of information X′ derives from the contents of the decomposed document and provides the proof of its consistency by verifying that the message does indeed contain the N characters specified, and this second piece of information is expressed in this example by the function (F1):

$$IDENT\_SPY MOD {\sum }_{Ci = 1}^{Ci = n} {C}_{j} mod 46027 + 4623 = {X}^{′}$$

The third piece of information Y′ also derives from the contents of the message and provides the proof of its sense or its meaning by relying on the ASCII value of each of the characters that make up the message. In this example, this third piece of information is obtained by the formula (F2):

$$IDENT\_SPY MOD {\sum }_{Ci = 1}^{Ci = n - 1} ( 2 val ASCII {C}_{i} - val ASCII {C}_{i + 1} ) mod 46027 + 4623 = {Y}^{′}$$

When concatenated, these last two results X′, Y′ form a second block or truncature of low-weight characters which, when concatenated with the first identification truncature of the transmitter CRYPT_IDENT, is concatenated here with the signed message M,S. The first truncature, the transmitter identification truncature, CRYPT_IDENT, confirms the identity of the signer of the decomposed and decoded message, while the second truncature X′, Y′ makes it possible to validate the message, or to repudiate it in the event that its contents are altered for whatever reason.

The system and process described above can also be used for electronic payments that are made by bearer bonds provided that there is a scratch-off area or other area that exposes the second truncature X′, Y′, which should then contain a random code resulting from the calculation that is made to validate the references of each of the bonds.

The principle of the generation of a result from processing, according to a particular example, information that is to be protected will now be explained in connection with FIGS. 3 and 4 in order to provide a better understanding of this invention.

For the sake of clarity, in the block diagram of the stages of the process shown in FIG. 3, calculation blocks or processing blocks that carry out the respective stages are each depicted in the form of several elementary frames that illustrate their functions, while their references are marked on the side in one hundred form 1.

A first result is generated by a calculation block 110 of transmitter 1 from strings of alphanumeric characters, in this case strings of alphabetic characters Ch1 to Ch4 and strings of numerical values Ch5 to Ch7, which represent data fields that are to be protected so as to be able to detect falsifications in the information or the documents or the identities of individuals, corporations, or objects.

The strings Ch1 to Ch7 are then condensed by a calculation block 111 into a set of, in this case, four intermediate results, references 11, 12, 13, 14, each of which consists of a number p of specified digits, which represent characters and numerical values of the strings Ch1 to Ch7 that are less than or equal to the value of the base that is used minus one unit, i.e., in this case not to exceed the digit 9 for the decimal base.

The intermediate results, references 11-14 (first result), are then transformed, by transformation calculation means 120, by an algorithm As that is drawn randomly from the set s, into a second result, reference 20, of p digits, expressed here in decimal base, whereby said result is generated by a conversion matrix into a decimal base that is stored in the calculation system of transmitter 1. The second result, reference 20, constitutes the first piece of information, identifying the transmitter (IDENT_SPY), which is later used here to determine the second piece of information (X′) and the third piece of information (Y′).

The first piece of information, identifying the transmitter (IDENT_SPY), is then transformed by encryption calculating means 130 into another encoded piece of information or encoded value, reference 30, which has a predetermined number of alphanumeric characters that are expressed in the identity mathematical base Y that is selected randomly by the transmitter 1, for example, a calculation system, in order to produce an encoded identifier. The base Y is selected at random by a random drawing algorithm of the calculation system and is drawn from a set, of size V, of available conversion bases that are stored in association with the calculation system. The calculation bases V can be located, as in the example presented, between bases 37 and 67, which are presented in the appendices. The number V of bases can also cover the range between base 37 and a base 127; this corresponds to a maximum of V=91 bases, whose mean value is 82.

In the series of characters that constitute the final encoded value, reference 30, calculation means 140 insert, at a variable rank r that is determined at random, the identifier character Y whose value identifies the conversion base. The rank r of the identifier character Y is provided by a pointer Z, which is also called a random key and is inserted at a predetermined or variable rank W by calculation in said encoded series 30.

When the rank or position W of the pointer Z is determined by calculation, said rank or position is calculated by, for example, calculating means 140 by taking the ASCII sum of one or more truncatures or blocks of the alphanumeric data fields of a truncature of the character string Ch1 to Ch7 and by determining this sum, modulo 9, in the example of the decimal base. The remainder that is obtained in this way by dividing by 9 determines the rank W of the pointer Z at a stage 41 in FIG. 4 and thus makes it possible to read this rank at a stage 42. In this example, the pointer Z is actually represented in the encoded series 30 by a library address, which is thus read. Dividing the pointer Z by the value s that is representative of the set of algorithms As then, at the end of stage 42, determines the rank r of the character Y that identifies the conversion base. Since the conversion base Y is thus known and is read at stage 43, the receiver 2 can back-calculate, going upwards, the numerical value IDENT_SPY in decimal base from the final cryptogram CRYPT_IDENT after blanking out the service characters Y and Z of ranks r and W at a stage 44. The references 41 to 44 can also represent the hardware and software means that provide for the above-indicated processing stages in the receiver 2.

The random calculations or drawings carried out by either the transmitter 1 terminal or the receiver 2 terminal can, however, be taken into account partially or entirely by a chip card or any other local or remote calculation device that communicates with the terminal in question. The fixed or mobile terminal and the chip card or other device are provided with the stored algorithms and information that are required to initiate the execution of one of the stages of the process. For example, the chip card can contain the conversion tables and provide the terminal with the necessary values.

The chip card can also contain the means for randomly drawing an algorithm from among the set s and/or the conversion table from the set V. The chip card can also contain the decoding algorithms for obtaining the transmitter identification information IDENT_SPY or the encoding algorithms for determining consistency from the strings Ch1 to Ch7. The chip card can also contain the consistency calculation algorithms X′ or X″ and the meaning calculation algorithms Y′ or Y″. Finally, the chip card can contain any combinations of the above-mentioned functions.

It is understood that the invention is in no way limited to the special case of the values provided in the example, be it either the range of conversion bases with the specific nature of their characters, numerical, alphanumeric, or other, or else the value of the calculation constants that are used and the respective lengths or respective numbers of characters of each of the truncatures, i.e., of the different blocks of characters.

Matrix of Base 37

APPENDIX 1
Matrix of Base 37

| b37 | B10 |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| a | 10 |
| b | 11 |
| c | 12 |
| d | 13 |
| e | 14 |
| f | 15 |
| g | 16 |
| h | 17 |
| i | 18 |
| j | 19 |
| k | 20 |
| l | 21 |
| m | 22 |
| n | 23 |
| o | 24 |
| p | 25 |
| q | 26 |
| r | 27 |
| s | 28 |
| t | 29 |
| u | 30 |
| v | 31 |
| w | 32 |
| x | 33 |
| y | 34 |
| z | 35 |
| A | 36 |

Matrix of Base 67

APPENDIX 2
Matrix of Base 67

| b10 | b67 |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | a |
| 11 | b |
| 12 | c |
| 13 | d |
| 14 | e |
| 15 | f |
| 16 | g |
| 17 | h |
| 18 | i |
| 19 | j |
| 20 | k |
| 21 | l |
| 22 | m |
| 23 | n |
| 24 | o |
| 25 | p |
| 26 | q |
| 27 | r |
| 28 | s |
| 29 | t |
| 30 | u |
| 31 | v |
| 32 | w |
| 33 | x |
| 34 | y |
| 35 | z |
| 36 | A |
| 37 | B |
| 38 | C |
| 39 | D |
| 40 | E |
| 41 | F |
| 42 | G |
| 43 | H |
| 44 | I |
| 45 | J |
| 46 | K |
| 47 | L |
| 48 | M |
| 49 | N |
| 50 | O |
| 51 | P |
| 52 | Q |
| 53 | R |
| 54 | S |
| 55 | T |
| 56 | U |
| 57 | V |
| 58 | W |
| 59 | X |
| 60 | Y |
| 61 | Z |
| 62 | [symbol] |
| 63 | $ |
| 64 | £ |
| 65 | & |
| 66 | % |

1. Process for ensuring the secure transmission of a message from a transmitter (1) to a receiver (2), in which the transmitter generates and integrates into the message a signature so as to produce a signed message, characterized by the fact that said process consists of the following stages:
the transmitter associates with the signed message transmission checking information (IDEM) deriving from the signed message according to a specified law, and
the transmitter generates and transmits (105) to the receiver data that represent the signed message and the transmission checking information (IDEM), and the receiver:
receives said transmitted data,
determines (204), according to said law, reception checking information (IDEM′) deriving from the message received, and
compares (205) reception checking information (IDEM′) against the transmission checking information (IDEM) in order to validate the message received in the event that they coincide.

2. Process according to claim 1, wherein said law implements a mathematical function.

3. Process according to claim 1, wherein the transmitter additionally generates and transmits transmitter identification information (CRYPT_IDENT or IDENT_SPY) that was used to personalize said law, and the receiver likewise personalizes the law according to the transmitter identification information (CRYPT_IDENT or IDENT_SPY) that is received in order to determine the reception checking information.

4. Process according to claim 3, wherein the transmitter sets up said law such that the transmission checking information (IDEM) is representative of at least one kind of information that is selected from within the group composed of message consistency information (X′) and message meaning information (Y′).

5. Process according to claim 4 together, wherein the message consistency information (X) is determined by a first quotient that is provided by dividing the transmitter identification information (IDENT_SPY) by a number of characters contained in the message.

6. Process according to claim 5, wherein a first remainder that is obtained by the above-mentioned division step is itself divided by a first number in order to obtain a second quotient and a second remainder, whereby the second remainder is added to a constant to obtain a predetermined number of characters, message consistency characters, after conversion into a base that is selected from among a set of conversion bases.

7. Process according to claim 6, wherein the remainder from the second quotient is divided by a first number in order to obtain a third quotient that is associated with a third remainder whose value is added to a constant value to obtain the message consistency information (X′).

8. Process according to claim 7, wherein the first number is 46027 and the constant is 4623.

9. Process according to claim 4, wherein the message consistency information (X′) is represented by characters, the number of which is below a threshold that represents a specified percentage relative to a size of the transmitted data.

10. Process according to claim 4 together, wherein the message meaning information (Y′) is determined by adding up a specified number of alphanumeric characters of the message, whereby each alphanumeric character has a value that is twice the ASCII value that is representative of the character in question, minus an ASCII value that is representative of an adjacent character, whereby the resulting sum is taken as a divisor of a dividend, which is the transmitter identification information (IDENT_SPY), so as to provide the message meaning information.

11. Process according to claim 4, wherein the message meaning information (Y′) is represented by characters, the number of which is below a threshold that represents a specified percentage relative to a size of the transmitted data.

12. Process according to claim 3, wherein the transmitter identification information (IDENT_SPY) is obtained:
by a stage for transcoding of strings, of specified sizes, of alphanumeric characters that represent data fields to be protected, thus providing a first set of intermediate results, each of which has a specified number of digits, and
a stage for transforming the first set of intermediate results by means of a transformation algorithm (As) that is randomly selected from among a set of algorithms (s), each of which uses an alphanumeric-character base that is particular to the algorithm in question in order to obtain a final result (IDENT_SPY) after a conversion matrix is used to convert the characters of the alphanumeric base of the selected algorithm into characters having numerical values of a predetermined base.

13. Process according to claim 12, wherein the transmitter identification information (IDENT_SPY) is transmitted in encoded form by transforming the transmitter identification information, in a specified base, into an encoded result that has a specified number of digits expressed in a mathematical base (Y) that is randomly selected from a set (V) of conversion bases in order to obtain an encoded identifier of the transmitter (CRYPT_IDENT) wherein information (Y), identifying the selected mathematical base, is inserted at a variable rank (r) that is a specified by a pointer (Z) that is inserted at a rank (W) for which the receiver has information for determining said rank.

14. Process according to claim 13, wherein the rank (r) of the information (Y) for identifying the selected mathematical base is defined by an integer quotient that is obtained by dividing a particular value, which is associated with the pointer (Z) by a table, by a number (s) that specifies the size of the set of algorithms (As).

15. Process according to claim 13, wherein the rank (W) of the pointer (Z) is inserted at a rank that is calculated by taking the sum, modulo 9, of ASCII codes of said intermediate result that represents++++ terms that specify a mathematical function that determines the transmitter identification information (IDENT_SPY).

16. Process according to claim 14, wherein the receiver:
calculates the sum of the ASCII codes of at least one block of data of the above-mentioned alphanumeric data field, whereby said block is received in the transmitter identification information,
expresses said sum in modulo 9, to determine the rank (W) of the pointer (Z),
reads said pointer (Z) that is received, and
calculates the rank (r) of the identification information (Y) of the selected mathematical base by dividing the particular value associated with the pointer (Z) by the value (s) that represents the size of the set of algorithms as expressed in a predetermined base, and
exploits the encoded information received (CRYPT_IDENT) after eliminating therefrom the identification information (Y) of the selected mathematical base and the pointer (Z).

17. Process according to claim 1, wherein said data are transmitted to the receiver via a data storage system.

18. Process according to claim 17, wherein the receiver (2) is also the transmitter (1).

19. System for securing the implementation of the process of claim 1, comprising a transmitter (1) that is associated with a receiver (2), whereby the transmitter is designed to generate and integrate with the message a signature so as to produce a signed message, wherein:
the transmitter (1) contains:
means (103, 104) for generating and associating with the signed message transmission checking information (IDEM) deriving from the signed message according to a specified law, and
means (105) for sending to the receiver (2) data that represent the signed message and the transmission checking information (IDEM),
and the receiver (2) contains:
means for receiving said transmitted data,
means (203, 204) for determining, according to said law, reception checking information deriving from the message received, and
means (205) for comparing the reception checking information against the transmission checking information (IDEM) in order to validate the received message in the event that they coincide.

20. Security system according to claim 19, wherein the transmission means (105) are also controlled by means (103) for generating the transmitter identification information (CRYPT_IDENT or IDENT_SPY) that was used to personalize said law, and the receiver likewise contains means for personalizing the law, according to the transmitter identification information (CRYPT_IDENT or IDENT_SPY) that was received by the reception means, which control the means (204) for determining the reception checking information.

21. Security system according to claim 19, wherein the transmitter is designed (104) such that said law ensures that the transmission checking information (IDEM) is representative of at least one kind of information that is selected from among the group that consists of the message consistency information and the message meaning information.

22. Data medium that contains a set of software for controlling a computer system for the purpose of implementing the process of claim 1, whereby the set of software contains at least one of the following two subsets:
a first subset for the transmitter that contains software for controlling the system for associating with the signed message the transmission checking information (IDEM) deriving from the signed message according to a specified law, and software for controlling the generation and transmission (105) to the receiver of the data that represent the signed message and the transmission checking information (IDEM), and
a second subset for the receiver that contains software for receiving the above-mentioned transmitted data, software (204) for determining, according to said law, the reception checking information (IDEM′) deriving from the received message, and software (205) for comparing the reception checking information (IDEM′) against the transmission checking information (IDEM) in order to validate the received message in the event that they coincide.

23. Software medium according to claim 22, wherein the first subset additionally contains software for generating and transmitting the transmitter identification information (CRYPT_IDENT or IDENT_SPY) that was used to personalize said law, and the second subset likewise contains software for personalization according to this same law based on the transmitter identification information (CRYPT_IDENT or IDENT_SPY) that is received in order to determine the reception checking information.

24. Data medium according to claim 22, wherein said law is set up such that the transmission checking information (IDEM) is representative of at least one kind of information that is selected from the group that consists of the message consistency information (X′) and the message meaning information (Y′).

25. Data medium according to claim 22, consisting of a chip card.
